(19) United States
(12) Patent Application Publication
(10) Pub. No.: US 2024/0202430 A1
(43) Pub. Date: Jun. 20, 2024

(54) BOOK PAGE DISPLAY METHOD AND APPARATUS, COMPUTER DEVICE AND STORAGE MEDIUM

(71) Applicant: Beijing Zitiao Network Technology Co., Ltd., Beijing (CN)

(72) Inventors: Xiaojie LI, Beijing (CN); Yiyong LI, Beijing (CN); Zhiying CAO, Beijing (CN); Liangjie XIE, Beijing (CN); Zhuqing QU, Beijing (CN)

(21) Appl. No.: 18/526,764

(22) Filed: Dec. 1, 2023

(30) Foreign Application Priority Data
Dec. 20, 2022 (CN) 202211640003.2

(51) Int. Cl. G06F 40/166; G06F 3/0483; G06F 40/30

(52) U.S. Cl. CPC G06F 40/166; G06F 3/0483; G06F 40/30

(57) ABSTRACT

The present disclosure provides a book page display method and apparatus, a computer device, and a storage medium, wherein the method comprises: in response to a trigger operation on a first book, displaying a book page of the first book; displaying, in the book page, a target topic matched with the first book; wherein at least one of the topic information of the target topic or a second book included in the target topic is matched with the first book.

### CROSS-REFERENCE TO RELATED APPLICATIONS

The present application is based on and claims priority of CN Application No. 202211640003.2, filed on Dec. 20, 2022, the disclosure of which is incorporated by reference herein in its entirety.

### TECHNICAL FIELD

The present disclosure relates to the technical field of computer technology, and in particular, to a book page display method and apparatus, a computer device and a storage medium.

### BACKGROUND

The book discussion communities provided by various kinds of book reading software usually include discussion topics posted by different users, each discussion topic may often include topic reviews made by different users on the discussion topics, and the topic reviews may include one or more books recommended by the users and review information of the users. When there is a demand of a user to look for a book to read, the user may find a book of interest to read depending on the topic reviews by searching directly the discussion topics of interest.

### SUMMARY

Embodiments of the present disclosure at least provide a book page display method and apparatus, a computer device and a storage medium.

In a first aspect, the embodiments of the present disclosure provide a book page display method, comprising:
in response to a trigger operation on a first book, displaying a book page of the first book; and
displaying, in the book page, a target topic matched with the first book; wherein the topic information of the target topic and/or second books included in the target topic are/is matched with the first book.

In a possible implementation, the book page is a reading home page of the first book; the displaying, in the book page, the target topic matched with the first book, comprises:
displaying, in the book page, the target topic in a position adjacent to a display position of introduction information of the first book.

In a possible implementation, subsequent to displaying a target topic matched with the first book, the method further comprises:
in response to a trigger operation directed to the target topic, displaying a target second book matched with the first book among the second books associated with the target topic, and/or, displaying a target topic review matched with the first book among the topic reviews included in the topic information.

In a possible implementation, the topic information includes at least one topic review;
the target topic is determined in such a manner as follows:
matching the topic information of initial topics and second books included in the initial topics with the first book respectively to determine candidate topics; wherein each of the candidate topics is matched with at least one of the topic reviews and the second books; and
determining the target topic from the candidate topics according to topic interaction data of the candidate topics and book reading conversion rate under the candidate topics.

In a possible implementation, the target topic is determined in such a manner as follows:
determining first plot information related to the book plot from the topic reviews included in the topic information of each initial topic, and determining second plot information of a second book included in the initial topic; and
screening out a target topic matched with third plot information of the first book from the initial topics, according to the first plot information and the second plot information.

In a possible implementation, the topic information of each of the initial topics is matched with the first book to determine candidate topics according to the following steps:
based on the topic title information, the topic introduction information and the matched book category as indicated by the topic information of each of the initial topics, determining first characteristic information corresponding to the initial topic;
based on the book title, the book introduction information and the book category of the first book, determining second characteristic information of the first book;
based on the first characteristic information and the second characteristic information, determining a first matching degree between the topic information of the initial topic and the first book; and
taking the initial topic with a corresponding first matching degree greater than a preset similarity threshold value as the candidate topic.

In a possible implementation, the second books included in each of the initial topics are matched with the first book to determine candidate topics according to the following steps:
for any one of the initial topics, in the case where there is a second book identical with the first book among the second books included in this initial topic, taking this initial topic as the candidate topic; or
in the case where there is no second book identical with the first book among the second books included in this initial topic, determining a second matching degree between each of the second books and the first book, and determining, in the initial topic, a first number of second books with a corresponding second matching degree greater than a preset similarity threshold value; and
in the case where the first number is greater than a first preset number, taking this initial topic as the candidate topic.

In a possible implementation, the topic information of each of the initial topics is matched with the first book to determine candidate topics according to the following steps:
for any one of the initial topics, determining third characteristic information of each topic review based on the book category of a second book and recommendation meaning information of a book recommendation reason in each topic review included in the initial topic;
based on the book category and the book introduction information of the first book, determining fourth characteristic information of the first book;
based on the third characteristic information of each topic review and the fourth characteristic information of the first book, determining a third matching degree between each of the topic reviews and the first book; and
if the second number of the topic reviews included in this initial topic is greater than a second preset number and there is a topic review with a corresponding third matching degree greater than the preset similarity threshold value in this initial topic, taking this initial topic as the candidate topic.

In a possible implementation, determining the target topic from the candidate topics according to topic interaction data of the candidate topics and book reading conversion rate under the candidate topics comprises:
in accordance with the topic interaction data of each of the candidate topics, selecting, from the candidate topics, candidate topics with an interaction data volume that is greater than or equals to a set data volume as to-be-determined topics; and
selecting, from the to-be-determined topics, the to-be-determined topic with the highest book reading conversion rate as the target topic.

In a possible implementation, the method further comprises:
if the interaction data volumes of topic interaction data of the candidate topics are all smaller than the set data volume, randomly selecting one of the candidate topics as the target topic.

In a second aspect, the embodiments of the present disclosure further provide a book page display apparatus, comprising:
a first display module configured to, in response to a trigger operation on a first book, display a book page of the first book; and
a second display module configured to display, in the book page, a target topic matched with the first book; wherein the topic information of the target topic and/or second books included in the target topic are/is matched with the first book.

In a third aspect, the optional implementations of the present disclosure further provide a computer device, which comprises a processor and a memory, wherein the memory stores machine-readable instructions executable by the processor, the processor is used for executing the machine-readable instructions stored in the memory, and when the machine-readable instructions are executed by the processor, the processor implements the steps in the above first aspect or in any one of possible implementations in the first aspect.

In a fourth aspect, the optional implementations of the present disclosure further provide a computer-readable storage medium, wherein the computer-readable storage medium stores thereon a computer program, and when the computer program is executed by a processor, the processor implements the steps in the above first aspect or in any one of possible implementations in the first aspect.

Reference is made to the description of the above book page display method for the description of effects of the book page display apparatus, the computer device and the computer-readable storage medium as mentioned above, and no repetition is further made here.

In order to make the above-mentioned objectives, features and advantages of the present disclosure more obvious and easier to understand, preferred embodiments are described in detail with reference to the accompanying drawings as follows.

### BRIEF DESCRIPTION OF THE DRAWINGS

In order to illustrate the technical solutions of the embodiments of the present disclosure in a more clearly manner, the accompanying drawings necessary to be used in the embodiments will be briefly described below. The accompanying drawings herein are incorporated in and form a part of the description; they illustrate embodiments consistent with the present disclosure and, together with the description, serve to illustrate the technical solutions of the present disclosure. It is to be understood that the following drawings only depict some embodiments of the present disclosure and are therefore not to be construed as limiting the scope, and for those skilled in the art, other relevant drawings may be derived from these drawings without any creative effort.

FIG. 1 is a flowchart of a book page display method provided by the embodiments of the present disclosure;

FIG. 2 is a schematic diagram of a book page provided by the embodiments of the present disclosure;

FIG. 3 is a schematic diagram of a book page display apparatus provided by the embodiments of the present disclosure; and

FIG. 4 is a schematic structural diagram of a computer device provided by the embodiments of the present disclosure.

### DETAILED DESCRIPTION

To make the objectives, technical solutions and advantages of the embodiments of the present disclosure more clearly comprehensible, the technical solutions in the embodiments of the present disclosure will be described clearly and completely with reference to the accompanying drawings in the embodiments of the present disclosure, and the embodiments as described are only a part of the embodiments of the present disclosure, rather than all of the embodiments. The components of the embodiments of the present disclosure, as described and illustrated herein, can generally be arranged and designed in a variety of different configurations. Thus, the following detailed description of the embodiments of the present disclosure is not intended to limit the scope of protection of the present disclosure, rather merely representative of selected embodiments of the present disclosure. All other embodiments, which can be derived by those skilled in the art based on the embodiments of the present disclosure without making any creative effort, shall fall within the scope of protection of the present disclosure.

Furthermore, the terms “first” “second” and the like in the description, the claims and the drawings described above in the embodiments of the present disclosure are used for distinguishing between similar elements and not necessarily for describing a particular sequential or chronological order. It should be understood that the data so used are interchangeable under appropriate circumstances, so that the embodiments described herein may be implemented in other sequences than those illustrated or described herein.

The term “a plurality of or a number of” herein means two or more. The term “and/or” describes an associated relationship of associated objects, indicating that there may be three kinds of relationships, for example, A and/or B may indicate three cases, namely A exists alone, A and B exist simultaneously, and B exists alone. The character “/” generally indicates that the former and latter associated objects are in an “or” relationship.

It has been found through studies that, since there are a large number of users with online reading habits and different users have different understandings of books, the same book may be recommended under multiple discussion topics, and although the users may find the needed books under different discussion topics, yet considering that the discussion topics not only can help the users to find books, but also can help other users to understand the core content of the first book, therefore, how to help the users better read books by using the discussion topics becomes a problem worthy of thought.

In summary, the discussion topics in the conventional book discussion communities are only intended to assist the users in searching for books, but cannot offer any help with reading to the users when the users read the books, and thus there are significant limitations.

As for the book page display method and apparatus, the computer device and the storage medium as provided by the embodiments of the present disclosure, since the target topic is screened out from a plurality of initial topics and at least one of the topic information and second books included by the target topic is matched with the first book, the core content of the first book can be better characterized by the content of the target topic that is screened out. Therefore, by displaying the target topic in the book page when the book page of the first book is displayed, not only is the richness of content displayed in the book page improved, but also help can be offered to the user in getting better knowledge of the highlights of the first book through the target topic, and further in quickly finding a book of interest to read according to the target topic in the book pages of different first books.

Based on the above studies, the present disclosure provides a book page display solution, wherein since the target topic is screened out from a plurality of initial topics and at least one of the topic information and second books included by the target topic is matched with the first book, the core content of the first book can be better characterized by the content of the target topic that is screened out. Therefore, by displaying the target topic in the book page when the book page of the first book is displayed, not only is the richness of content displayed in the book page improved, but also help can be offered to the user in getting better knowledge of the highlights of the first book through the target topic, and further in quickly finding a book of interest to read according to the target topic in the book pages of different first books.

All the above drawbacks are the conclusions made by the inventor after practical and careful studies, and therefore, the discovery process of the above problems and the solutions proposed by the present disclosure with respect to the above problems in the following description should both be the contributions made by the inventor to the present disclosure in the course of the present disclosure.

It should be noted that similar reference signs and letters refer to similar items in the subsequent drawings, and thus, once an item is defined in one drawing, it is not necessary to further define and explain it in the subsequent drawings.

To facilitate understanding of the present embodiments, a book page display method as disclosed in the embodiments of the present disclosure will be first described in detail. The execution subject of the book page display method provided by the embodiments of the present disclosure is generally a terminal device with certain computing power or other processing devices, wherein the terminal device may be a User Equipment (UE), a mobile device, a user terminal, a terminal, a Personal Digital Assistant (PDA), a hand-held device, a computer device, etc.; in some possible implementations, the book page display method may be implemented by a processor calling computer-readable instructions stored in a memory.

The book page display method provided by the embodiments of the disclosure will be described as follows by taking the execution subject being a computer device as an example.

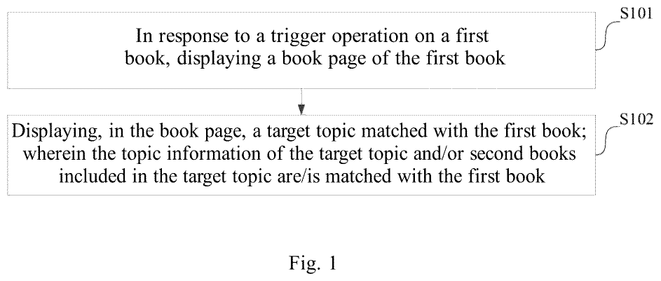

As shown in FIG. 1, which is a flowchart of a book page display method provided by the embodiments of the present disclosure, the method may comprise the following steps:
S101: in response to a trigger operation on a first book, displaying a book page of the first book.

Here, the first book may be any type of book for online reading. For example, an online novel as provided in novel reading software, an article for online reading, a novel for online reading and poetry for online reading as provided in an article reading website, and the like.

The book page of the first book is a page related to the first book, which is displayed after the first book is triggered, and this page may be any page in the first book. For example, a first book's first page, a presentation page set in advance for the first book, a first book's last page, and so on.

A trigger operation on a first book may be an operation initiated by the user which confirms opening of the first book, for example, an operation to click on the first book.

For example, after the user gets into the novel reading software, a plurality of books may be displayed on the home page of the novel reading software, and then, in response to a click operation of the user on the first book, the book page of the first book may be generated and displayed.

For another example, in response to a click operation of the user on the first book in any topic displayed in a book discussion community, the book page of the first book may be generated and displayed.
S102: displaying, in the book page, a target topic matched with the first book; wherein the topic information of the target topic and/or second books included in the target topic are/is matched with the first book.

Here, the book page may specifically include information such as the target topic, the book cover of the first book, the book title, the book source, the book update status, the word count of the book, introduction information of the book, and tag information of the book. The target topic may be displayed in any position in the book cover, for example, a middle position, a top position, etc.

The target topic is a topic that is screened out from a plurality of initial topics, and the initial topics are namely topics which are initiated in advance by users in a book discussion community and are used for the search of books. Each initial topic can include one or more answers by the users regarding the initial topic, one answer is referred to as one topic review, and one topic review can include information such as at least one second book and book recommendation reason(s) for the second book (s). Since different topic reviews originate from different users, the second books in different topic reviews may be duplicated or completely different, to which no definition is made herein.

The topic information may include topic title information of the initial topic and the topic reviews. For example, the topic title information may be “running out of books, begging for recommendation of a highly scored book of XX type”, “begging for XXXXXXXXXXXXXX”; the second book in the topic reviews may be Book A, and the book recommendation reason may be “Book can be regarded as the acme of XXX”.

Different pieces of topic information include different second books, and the second book information included in one piece of topic information may be the second book in the topic reviews on the initial topic. Different second books possess different pieces of book attribute information, wherein the book attribute information may include, for example, the book title, the book category, the book introduction information, the book identifier, the book author, etc. of the second books.

In specific implementations, all initial topics can be acquired from the book discussion community, and then the topic information of each initial topic and the included second books are respectively matched with the first book, so as to determine whether there are parts that are matched with the first book in the topic information of each initial topic and the included second books. Then, one target topic which is most matched with the first book can be screened out from the initial topics with the matched parts. For example, the target topic may be determined and an associated relationship between the first book and the target topic may be established according to the similarity between each of the initial topic with the matched parts and the first book. It should be noted that, for one target topic corresponding to a first book, at least one of the topic information of the target topic and second books included in the target topic is matched the first book. Further, subsequent to the response to a trigger operation on the first book, the target topic may be determined according to the associated relationship, and the target topic may be displayed in a book page of the first book.

It should be noted that the book page, without the target topic, corresponding to the first book may be displayed first, and the target topic is displayed in the book page after the display of the book page is completed; or the target topic can be acquired at the same time of determining the book page corresponding to the first book, which is to be displayed, and then the book page including the target topic is directly displayed.

In this way, since the target topic is screened out from a plurality of initial topics and at least one of the topic information and second books included by the target topic is matched with the first book, the core content of the first book can be better characterized by the content of the target topic that is screened out. Therefore, by displaying the target topic in the book page when the book page of the first book is displayed, not only is the richness of content displayed in the book page improved, but also help can be offered to the user in getting better knowledge of the highlights of the first book through the target topic, and further in quickly finding a book of interest to read according to the target topic in the book pages of different first books.

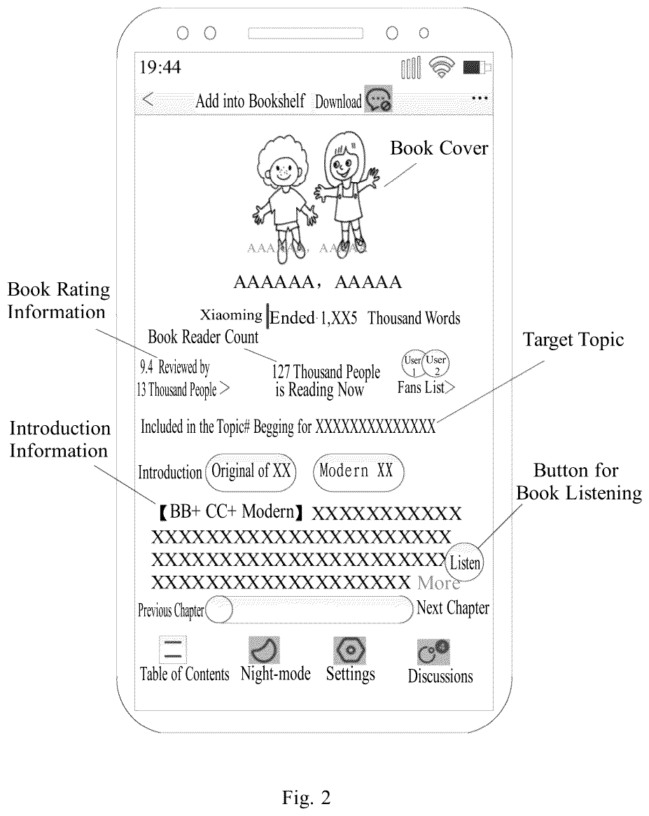

In one embodiment, the book page may be the first page for reading of the first book, and the introduction information of the first book may be displayed in the first page for reading. For S102, the target topic may be displayed, in the book page, in a position adjacent to the display position of introduction information of the first book. Herein, the adjacent position may be an upper adjacent position of the display position of the introduction information, or a lower adjacent position of the display position of the introduction information. As shown in FIG. 2, it is a schematic diagram of a book page provided by the embodiments of the present disclosure. Herein, in FIG. 2, the book title (i.e., “AAAAAA, AAAAAA”, the book cover, the book author (i.e., Xiaoming in FIG. 2), the book update status (i.e., Ended), the word count of the book (i.e., 1,XX5 Thousand Words in FIG. 2), the book rating Information, the book reader count, fans list, a target topic above the introduction information (i.e., “#Begging for XXXXXXXXXXXXXX” in FIG. 2), the introduction information (i.e., content corresponding to the introduction part in FIG. 2, including book tags such as Original of XX and Modern XX) of the first book are displayed, and besides, an “Add into Bookshelf” button for adding the first book into the bookshelf, a “Download” button for downloading the first book, a “Book Listening” button for switching to a book listening mode by a user, a “Table of Contents” button for viewing the table of contents of the first book, a “Night-mode” button for adjusting a page color mode, a “Settings” button for setting a reading manner, a “Discussions” button for viewing the discussion information for the first book, a “Return” button for exiting the book page, a “Previous Chapter” button for viewing the previous chapter of the first book and a “Next Chapter” button for view the next chapter of the first book are also displayed in FIG. 2.

In this way, by displaying the target topic in a position adjacent to the display position of the introduction information of the first book (i.e. in a middle position of the book page), a clear and visualized display of the target topic in a key position of the book page is achieved, which makes it easier for the user to get better knowledge of the highlights and the contents of the first book according to the target topic.

In one embodiment, subsequent to displaying a target topic matched with the first book, it is further possible to, in response to a trigger operation directed to the target topic, display a target second book matched with the first book among the second books associated with the target topic, and/or, display a target topic review matched with the first book among the topic reviews included in the topic information.

Here, the target second book is namely a book having a high matching degree with the contents of the first book, among the second books included in the target topic. The target topic reviews are namely topic reviews related to the first book, among the topic reviews included in the topic information. The trigger operation on the target topic may be, for example, an operation of clicking the target topic in a book page.

Illustratively, it is possible to, in response to the click operation, jump to a target topic page, in which the target second book and the target topic reviews are displayed.

In one embodiment, with respect to the topic information of each initial topic, the topic information may include at least one topic review. The target topic corresponding to the first book may be determined in such a manner as follows:
S1: matching the topic information of initial topics and second books included in the initial topics with the first book respectively to determine candidate topics; wherein each of the candidate topics is matched with at least one of the topic reviews and the second books.

Here, the initial topics are namely acquired discussion topics from different users. Illustratively, after user A posts an initial topic for looking for books in a book discussion community, users B, C and D may individually make a review that includes recommended accordant second books and written book recommendation reasons within the initial topic. Herein, the topic information of the initial topic is namely the information which is posted by user A for looking for books, reviews posted by the users B, C and D respectively are referred to as different topic reviews, and the second books recommended by users B, C and D respectively are namely the second books included in the initial topic.

In specific implementations, initial topics from each user can be acquired from the book discussion community in advance, and topic information of each initial topic and the included second books can be determined. Then, for each initial topic, the topic information of the initial topic and the included second books may be respectively matched with the first book to determine whether there is at least one part matched with the first book in the topic information and the second books. In an affirmative case, this initial topic is regarded as a candidate topic. In other words, the candidate topic is not necessarily a topic where the topic information and the second books are both matched with the first book, rather, as long as at least one of the topic information and the second books is matched with the first book, the topic can be regarded as the candidate topic. If a negative case, that is, in the case where neither of the topic information of the initial topic and the included second books is matched with the first book, the initial topic is filtered out. Based on the matching of each initial topic, each candidate topic can be accurately screened out from the initial topics.

In one embodiment, the topic information may include the topic title information, the topic introduction information, and the matched book category, in which case the topic information of each initial topic can be matched with the first book to determine candidate topics according to the following steps:

Sub-step One, based on the topic title information, the topic introduction information and the matched book category as indicated by the topic information of each of the initial topics, determining first characteristic information corresponding to the initial topic.

Sub-step Two, based on the book title, the book introduction information and the book category of the first book, determining second characteristic information of the first book.

Here, the book category matched with the initial topic is namely the book category indicated by the topic information of the initial topic and needed by the user. For example, the initial topic may be “running out of books, begging for recommendation of books of a modern type with XXXXXXXXXXX”, wherein the modern type with XXXXXXXXXXX is the book category matched with the initial topic. The first characteristic information is used to characterize at least one of the topic title information, the topic introduction information and the matched book category. The second characteristic information is used to characterize at least one of the book name, the book introduction information, and the book category of the first book.

In specific implementations, for each initial topic, information extraction can be performed on topic information of the initial topic to extract the topic title information, the topic introduction information and the matched book category. Then, characteristic extraction can be performed on the topic title information, the topic introduction information and the book category corresponding to each initial topic by using a preset trained target neural network, so as to obtain first characteristic information corresponding to each initial topic. Meanwhile, the book title, the book introduction information and the book category can be extracted from the book information of the first book, and the target neural network is used for performing characteristic extraction to obtain second characteristic information.

Optionally, in the case where the topic information is different, after the topic information is extracted, the extracted information may only include one or more of the topic title information, the topic introduction information, and the matched book category. In this case, the first characteristic information may be generated by using one or more pieces of information extracted from the topic information.

Sub-step Three, based on the first characteristic information and the second characteristic information, determining a first matching degree between the topic information of the initial topic and the first book.

In specific implementations, a first matching degree between the first characteristic information and the second characteristic information may be calculated, and this matching degree may be used as a first matching degree between the topic information of the initial topic and the first book. For example, a sub-matching degree between part of characteristic information for characterizing the topic title information and the topic introduction information in the first characteristic information and part of characteristic information for characterizing the book title and the book introduction information in the second characteristic information may be calculated, and a sub-matching degree between part of characteristic information for characterizing the book category in the first characteristic information and part of characteristic information for characterizing the book category in the second characteristic information may be calculated. Then, a first matching degree may be determined by performing weighted average on the two sub-matching degrees, by averaging the two sub-matching degrees, and the like.

Sub-step Four, taking the initial topic with a corresponding first matching degree greater than a preset similarity threshold value as the candidate topic.

Here, the preset similarity threshold value may be set according to an actual recommendation demand, to which no definition is specifically made in the embodiments of the present disclosure. For example, the preset similarity threshold value may be 0.7, 0.8 or 0.9, etc.

For example, after the first matching degree between each initial topic and the first book is determined by the Sub-steps One to Three, the initial topic with a corresponding first matching degree greater than the preset similarity threshold value may be screened out, and the initial topic that is screened out is taken as a candidate topic.

In one implementation, with respect to the step “matching second books included in the initial topics with the first book to determine candidate topics”, in specific implementation, for any one of the initial topics, it can be determined first whether there is a second book identical with the first book among the second books included in this initial topic, and then a candidate topic is determined according to the determination result. There are specifically two cases as follows:

Case One, there is a second book identical with the first book among the second books included in this initial topic, taking this initial topic as the candidate topic.

Illustratively, if it is determined that there is a second book identical with the first book among the second books included in one initial topic, namely, it can be determined that the first book is included in this initial topic, taking this initial topic directly as the candidate topic.

Case Two, there is no second book identical with the first book among the second books included in this initial topic, determining a second matching degree between each of the second books and the first book, and determining, in the initial topic, a first number of second books with a corresponding second matching degree greater than a preset similarity threshold value; in the case where the first number is greater than a first preset number, taking this initial topic as the candidate topic.

Here, the first preset number may be set according to an actual recommendation demand, to which no definition is specifically made in the embodiments of the present disclosure. For example, the first preset number may be 4, 5 or 6, etc.

Illustratively, in the case where it is determined that there is no second book identical with the first book among all of the second books included in one initial topic, for each of the second books included in this initial topic, in accordance with the book title, the book introduction information and the book category of this second book, as well as the book title, the book introduction information and the book category of the first book, a second matching degree may be determined between this second book and the first book.

Then, in accordance with the second matching degree between each of the second books in this initial topic and the first book, a second book with a corresponding second matching degree greater than the preset similarity threshold value may be screened out from the second books corresponding to this initial topic, and the first number of second books with a corresponding second matching degree greater than a preset similarity threshold value may be obtained. Finally, it may be determined whether the first number is greater than the first preset number or not, if yes, this initial topic is taken as a candidate topic, and if not, this initial topic is filtered out.

Based on the above steps, the second books of the initial topics can be used to accurately screen out the candidate topics matched with the first book from the initial topics.

In one embodiment, the topic information may include at least one topic review, in which case the topic information of each initial topic can be matched with the first book to determine candidate topics according to the following steps:

Step A, for any one of the initial topics, determining third characteristic information of each topic review based on the book category of a second book and recommendation meaning information of a book recommendation reason in each topic review included in the initial topic.

Here, the topic reviews included in the initial topic are namely the topic reviews included in the topic information of the initial topic. The third characteristic information is used to characterize the book category and the recommendation meaning information. Herein, the recommendation meaning information is used to characterize the semantic meaning of the book recommendation reasons.

Illustratively, for any one of the initial topics, the book recommendation reasons in the topic information of this initial topic may be analyzed to determine the recommendation meaning information of the book recommendation reasons.

Then, characteristic extraction can be performed on the book category of the second book included in the topic review of each initial topic and on the recommendation meaning information corresponding to this topic review by using a target neural network, so as to obtain third characteristic information of each topic review.

Step B, based on the book category and the book introduction information of the first book, determining fourth characteristic information of the first book.

In specific implementations, characteristic extraction can be performed on the book category of the first book and the book introduction information of the first book by using a target neural network, so as to obtain fourth characteristic information of the first book.

Step C, based on the third characteristic information corresponding to each topic review and the fourth characteristic information of the first book, determining a third matching degree between each of the topic reviews and the first book.

In specific implementations, a third matching degree between the third characteristic information and the fourth characteristic information may be calculated, and this matching degree may be used as a third matching degree between the topic review and the first book. For example, a sub-matching degree between part of characteristic information for characterizing the recommendation meaning information in the third characteristic information and part of characteristic information for characterizing the book introduction information in the fourth characteristic information may be calculated, and a sub-matching degree between part of characteristic information for characterizing the book category in the third characteristic information and part of characteristic information for characterizing the book category in the fourth characteristic information may be calculated. Then, a third matching degree may be determined by performing weighted average on the two sub-matching degrees, by averaging the two sub-matching degrees, and the like.

Optionally, it is also possible to, based on the third characteristic information corresponding to each topic review and the second characteristic information of the first book, determine a third matching degree between each of the topic reviews and the first book. Reference can be made to the above Step C for the steps of calculating the third matching degree by using the third characteristic information and the second characteristic information, on which no repeated description is further made here.

Step D, if the second number of the topic reviews included in this initial topic is greater than a second preset number and there is a topic review with a corresponding third matching degree greater than the preset similarity threshold value in this initial topic, taking this initial topic as the candidate topic.

Here, the second preset number may be set according to an actual recommendation demand, to which no definition is specifically made in the embodiments of the present disclosure. For example, the second preset number may be 10 or 12, etc.

In specific implementations, for each of the initial topics, it may be determined first whether the second number of the topic reviews of this initial topic is greater than the second preset number, if yes, it may be further determined whether there is a topic review with a corresponding third matching degree greater than the preset similarity threshold value in this initial topic, and if yes, this initial topic may be taken as the candidate topic. If the second number of the topic reviews of this initial topic is not greater than the second preset number and/or there is no topic review with a corresponding third matching degree greater than the preset similarity threshold value in this initial topic, this initial topic may be filtered out.

It should be noted that, in one implementation, the topic title information and the topic introduction information and the matched book category as indicated by the topic information and the topic reviews and second books in the topic information may be used together to screen the initial topics, so as to obtain the candidate topics. In this way, the comprehensiveness of the determined candidate topics can be improved, which effectively prevents the problem that part of the initial topics are missed out.

In one embodiment, the topic reviews may also further include information related to the book plot as input by the user, and thus, the plot information can also be used for determining the target topic. Specifically, first plot information related to the book plot can be determined from the topic reviews included in the topic information of each initial topic, and second plot information of a second book included in the initial topic can be determined.

Illustratively, for any one of the initial topics, semantic recognition may be performed on each topic review included in this initial topic, so as to determine the first plot information related to the book plot in each topic review. Meanwhile, the second plot information corresponding to each second book respectively included in this initial topic can be determined.

Then, a target topic matched with the third plot information of the first book can be screened out from the initial topics, according to the first plot information and the second plot information.

In specific implementations, the third plot information corresponding to the first book may be determined first. Then, for each of the initial topics, a first plot matching degree between the first plot information and the third plot information corresponding to each topic review in the initial topic can be calculated, and a second plot matching degree between the second plot information of each second book included in each topic review and the third plot information respectively can be calculated. Subsequently, a weighted summation of the first plot matching degrees and the second plot matching degrees corresponding to this initial topic can be performed to determine a target plot matching degree corresponding to this initial topic. Finally, the initial topic with the highest target plot matching degree may be taken as the target topic.

Alternatively, after the first plot matching degrees and the second plot matching degrees are obtained, for each topic review, it may be determined whether or not this topic review satisfies the following two conditions at the same time: Condition 1, the first plot matching degree corresponding to the topic review is greater than the preset plot matching degree; Condition 2, there is a second book with the second plot matching degree greater than the preset plot matching degree in the topic review. If yes, this topic review may be taken as a target topic review. In this way, the number of the target topic reviews in each initial topic may be determined, and then the initial topic with the greatest number may be taken as the target topic.
S2: determining the target topic from the candidate topics according to topic interaction data of the candidate topics and book reading conversion rate under the candidate topics.

Here, topic interaction data may be data for reflecting topic popularity, such as the review count of a topic, a forward count of a topic, the like count of a topic, etc. A book reading conversion rate is used to characterize the rate at which the first book is read through candidate topics.

Illustratively, the candidate topics may be divided into different topic groups according to the interaction data volume of the topic interaction data of the candidate topics, wherein the different topic groups correspond to different intervals of data volume. For example, the interaction data volume corresponding to the data volume interval 1 is 0 to 60 times, the interaction data volume corresponding to the data volume interval 2 is 61 to 80 times, the interaction data volume corresponding to the data volume interval 3 is 81 to 100 times, and the interaction data volume corresponding to the data volume interval 4 is 100 times and more. Then, the book reading conversion rate under each candidate topic in each topic group can be weighted according to the weighted value corresponding to each data volume interval, so as to obtain the weighted book reading conversion rate corresponding to each candidate topic. Finally, the candidate topic with the highest weighted book reading conversion rate as the target topic.

In this way, by screening the candidate topics through the topic interaction data and the book reading conversion rate, the target topics with certain topic popularity and higher book reading conversion rate can be screened out.

In one embodiment, regarding the above S2, the following steps may be performed:
S2-1: in accordance with the topic interaction data of each of the candidate topics, selecting, from the candidate topics, candidate topics with an interaction data volume that is greater than or equals to a set data volume as to-be-determined topics.

Illustratively, the set data volume may be set according to an actual recommendation demand, to which no definition is specifically made in the embodiments of the present disclosure. For example, the set data volume is 100, 200 or 300, etc. Herein, in the case where the interaction data volume of the candidate topic is smaller than the set data amount, this may indicate that the number of samples for the candidate topic is relatively small.

In specific implementations, the interaction data volume of each candidate topic may be compared with the set data volume respectively, so as to determine whether there is a to-be-determined topic with an interaction data volume that is greater than or equals to the set data volume in the candidate topics.
S2-2: selecting, from the to-be-determined topics, the to-be-determined topic with the highest book reading conversion rate as the target topic.

In specific implementations, in the case where there are to-be-determined topics, the to-be-determined topic with the highest book reading conversion rate may be taken as the target topic, according to the book reading conversion rate of each to-be-determined topic.

In another embodiment, if the interaction data volumes of the candidate topics are all smaller than the set data volume, one of the candidate topics may be randomly selected as the target topic.

Here, in the case where the interaction data volumes of the candidate topics are all smaller than the set data amount, this indicates that the sample numbers of the candidate topics are all relatively small. Thus, there is no much difference in the reference value of each of the candidate topics, and one candidate topic can be randomly selected therefrom as the target topic. In this way, the flexibility of target topic selection can be improved.

It can be understood by those skilled in the art that in the above method of the specific embodiment, the order in which the steps are listed does not imply a strict order of execution and does not impose any limitation on the implementing process, rather the specific order of execution of the steps should be determined by functions and possible inherent logic thereof.

Based on the same inventive concept, a book page display apparatus corresponding to the book page display method is also provided in the embodiments of the present disclosure, and since the problem-solving principle of the apparatus in the embodiments of the present disclosure is similar to the above book page display method in the embodiments of the present disclosure, references can be made to the implementation of the method for the implementation of the apparatus, and the repeated parts are no longer described herein.

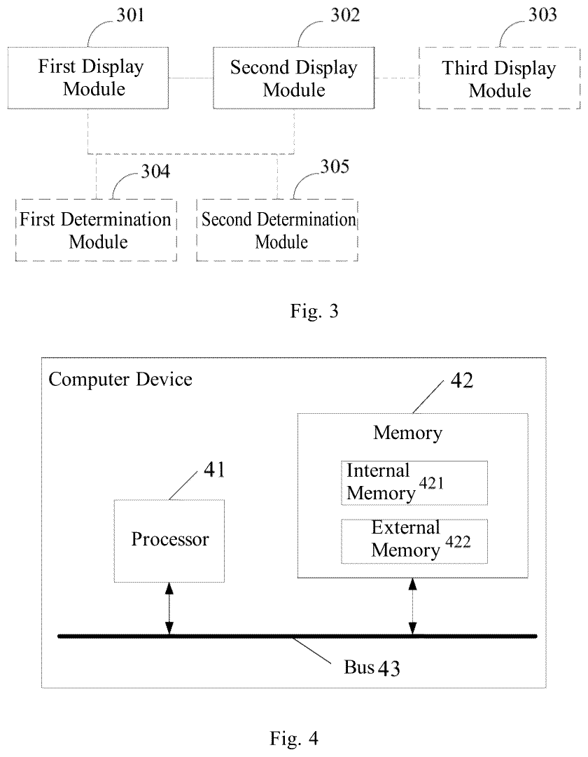

As shown in FIG. 3, it is a schematic diagram of a book page display apparatus provided by the embodiments of the present disclosure, which comprises:
a first display module 301 configured to, in response to a trigger operation on a first book, display a book page of the first book; and
a second display module 302 configured to display, in the book page, a target topic matched with the first book; wherein the topic information of the target topic and/or second books included in the target topic are/is matched with the first book.

In a possible implementation, the book page is a reading home page of the first book; the second display module 302, when displaying, in the book page, a target topic matched with the first book, is configured to:
display, in the book page, the target topic in a position adjacent to a display position of introduction information of the first book.

In a possible implementation, the apparatus further comprises:
a third display module 303, subsequent to displaying a target topic matched with the first book, configured to:
in response to a trigger operation directed to the target topic, displaying a target second book matched with the first book among the second books associated with the target topic, and/or, displaying a target topic review matched with the first book among the topic reviews included in the topic information.

In a possible implementation, the topic information includes at least one topic review;
the apparatus further comprises a first determination module 304 configured to determine the target topic in such a manner as follows:
matching the topic information of initial topics and second books included in the initial topics with the first book respectively to determine candidate topics; wherein each of the candidate topics is matched with at least one of the topic reviews and the second books; and
determining the target topic from the candidate topics according to topic interaction data of the candidate topics and book reading conversion rate under the candidate topics.

In in a possible implementation, the apparatus further comprises a second determination module 305 configured to determine the target topic in such a manner as follows:
determining first plot information related to the book plot from the topic reviews included in the topic information of each initial topic, and determining second plot information of a second book included in the initial topic; and
screening out a target topic matched with third plot information of the first book from the initial topics, according to the first plot information and the second plot information.

In a possible implementation, the first determination module 304 is configured to match the topic information of each of the initial topics with the first book to determine candidate topics according to the following steps:
based on the topic title information, the topic introduction information and the matched book category as indicated by the topic information of each of the initial topics, determining first characteristic information corresponding to the initial topic;
based on the book title, the book introduction information and the book category of the first book, determining second characteristic information of the first book;
based on the first characteristic information and the second characteristic information, determining a first matching degree between the topic information of the initial topic and the first book; and
taking the initial topic with a corresponding first matching degree greater than a preset similarity threshold value as the candidate topic.

In a possible implementation, the first determination module 304 is configured to match the second books included in of each of the initial topics with the first book to determine candidate topics according to the following steps:
for any one of the initial topics, in the case where there is a second book identical with the first book among the second books included in this initial topic, taking this initial topic as the candidate topic; or
in the case where there is no second book identical with the first book among the second books included in this initial topic, determining a second matching degree between each of the second books and the first book, and determining, in the initial topic, a first number of second books with a corresponding second matching degree greater than a preset similarity threshold value; and
in the case where the first number is greater than a first preset number, taking this initial topic as the candidate topic.

In a possible implementation, the first determination module 304 is configured to match the topic information of each of the initial topics with the first book to determine candidate topics according to the following steps:
for any one of the initial topics, determining third characteristic information of each topic review based on the book category of a second book and recommendation meaning information of a book recommendation reason in each topic review included in the initial topic;
based on the book category and the book introduction information of the first book, determining fourth characteristic information of the first book;
based on the third characteristic information of each topic review and the fourth characteristic information of the first book, determining a third matching degree between each of the topic reviews and the first book; and
if the second number of the topic reviews included in this initial topic is greater than a second preset number and there is a topic review with a corresponding third matching degree greater than the preset similarity threshold value in this initial topic, taking this initial topic as the candidate topic.

In a possible implementation, the first determination module 304, when determining the target topic from the candidate topics according to topic interaction data of the candidate topics and book reading conversion rate under the candidate topics, is configured to:
in accordance with the topic interaction data of each of the candidate topics, select, from the candidate topics, candidate topics with an interaction data volume that is greater than or equals to a set data volume as to-be-determined topics; and
selecting, from the to-be-determined topics, the to-be-determined topic with the highest book reading conversion rate as the target topic.

In a possible implementation, the first determination module 304 is further configured to:
if the interaction data volumes of topic interaction data of the candidate topics are all smaller than the set data volume, randomly select one of the candidate topics as the target topic.

For the description of the processing flow of each module in the apparatus and the interaction flow between the modules, references may be made to the relevant description in the above method embodiments, and will not be described in detail herein.

Based on the same technical concept, the embodiments of the present application further provide a computer device. With reference to FIG. 4, it is a schematic structural diagram of a computer device provided by the embodiments of the present disclosure, which comprises:
a processor 41, a memory 42 and a bus 43. Herein, the memory 42 stores machine-readable instructions executable by the processor 41, the processor 41 is used for executing the machine-readable instructions stored in the memory 42, and when the machine-readable instructions are executed by the processor 41, the processor 41 implements the following steps: S101: in response to a trigger operation on a first book, displaying a book page of the first book; and S102: displaying, in the book page, a target topic matched with the first book; wherein the topic information of the target topic and/or second books included in the target topic are/is matched with the first book.

The above memory 42 includes an internal memory 421 and an external memory 422; the internal memory 421 here is also referred to as an internal memory, which is used for temporarily storing computing data in the processor 41 and data exchanged with the external memory 422, and the processor 41 exchanges data with the external memory 422 via the internal memory 421. When the computer device runs, the processor 41 communicates with the memory 42 via the bus 43, so that the processor 41 executes the execution instructions as mentioned in the above method embodiments.

The embodiments of the present disclosure further provide a computer-readable storage medium, wherein the computer-readable storage medium stores thereon a computer program which, when executed by a processor, enables the processor to implement the steps of the book page display method in the above method embodiments. Herein, the storage medium may be a volatile or non-volatile computer-readable storage medium.

The computer program product provided by the embodiments of the present disclosure comprises a computer-readable storage medium that stores program code, and instructions included in the program code may be used to execute the steps of the book page display method in the above method embodiments. Reference can be made to the above method embodiments for details, and no further description is made herein.

The computer program product may be implemented by hardware, software or a combination thereof. In an optional embodiment, the computer program product is embodied as a computer storage medium, and in another optional embodiment, the computer program product is embodied as a software product, such as Software Development Kit (SDK) or the like.

It can be clearly understood by those skilled in the art that, in view of convenience and simplicity of description, for the specific working process of the system and the apparatus as described above, references may be made to the corresponding process in the foregoing method embodiments, and no more details are described herein. In the several embodiments provided in the present disclosure, it should be understood that the disclosed system, apparatus and method may be implemented in other ways. The above-described apparatus embodiments are merely illustrative; for example, the division of the units is merely one type of logical function division, and in practical implementation, other division manners may exist; a further example is that multiple units or components may be combined or integrated into another system, or some features may be omitted or not implemented. In addition, the shown or discussed coupling or direct coupling or communication connection between one another may be realized via some communication interfaces, and indirect coupling or communication connection between devices or units and may be in an electrical, mechanical or other form.

The units described as separate components may or may not be physically separate, and components displayed as units may or may not be physical units, that is, they may be located in one position, or may be distributed on multiple network units. Some or all of the units can be selected according to actual needs to achieve the purpose of the solution of the present embodiment.

In addition, functional units in the embodiments of the present disclosure may be integrated into one processing unit, or each unit may exist alone physically, or two or more units may be integrated into one unit.

The functions, if implemented in software functional units and sold or used as a stand-alone product, may be stored in a non-transitory computer-readable storage medium which is executable by a processor. Based on such understanding, the essential part or the part contributing to the prior art of the technical solutions of the present disclosure, or parts of the technical solutions, may be embodied in the form of a software product, and the computer software product is stored in a storage medium and comprises several instructions for enabling a computer device (which may be a personal computer, a server, or a network device) to execute all or part of the steps of the method described in the embodiments of the present disclosure. And the aforementioned storage medium includes U disk, removable hard disk, Read-Only Memory (ROM), Random Access Memory (RAM), magnetic disk or optical disk, and other media that can store program code.

If the technical solutions of the present application involve personal information, a product to which the technical solutions of the present application apply has already explicitly informed any concerned person of personal information processing rules before processing the personal information and obtained a personal willing consent. If the technical solutions of the application involve sensitive personal information, a product to which the technical solutions of the present application apply has already obtained individual consent before processing the sensitive personal information and simultaneously met the requirement of “explicit consent”. For example, at a personal information acquisition apparatus such as a camera, an explicit and significant identifier is provided to inform that the personal information acquisition area is entered and the personal information will be acquired, and if a person voluntarily enters the acquisition area, it is considered that the person agrees to acquisition of the personal information; alternatively, on the apparatus for processing the personal information, in the case where the personal information processing rules are informed of by using obvious identifiers/information, personal authorization is obtained through pop-up window information or by means of requesting the person to upload personal information thereof, etc.; wherein the personal information processing rules may include information such as the personal information processing subject, personal information processing purposes, the processing manners, and types of personal information to be processed.

Finally, it should be noted that, the embodiments as described above are merely specific implementations of the present disclosure, which are only intended to be used for illustrating the technical solutions of the present disclosure, rather than for limiting the same, and the scope of protection of the present disclosure is not limited thereto; although the present disclosure has been described in detail with reference to the above-mentioned embodiments, those of ordinary skill in the art shall understand that the technical solutions described in the above-mentioned embodiments may still be modified or changed in a conceivable manner, or some or all of the technical features may be equivalently replaced within the technical scope as disclosed by the present disclosure by any one of ordinary skill in the art; however, such modifications or replacements will not cause the essence of the corresponding technical solutions to depart from the scope of the technical solutions of the embodiments of the present disclosure, and they should be construed as being included therein. Thus, the scope of protection of the present disclosure shall be determined by the terms of the claims.

What is claimed is:

1. A book page display method, comprising:
in response to a trigger operation on a first book, displaying a book page of the first book;
displaying, in the book page, a target topic matched with the first book; wherein at least one of the topic information of the target topic or second books included in the target topic is matched with the first book.

2. The method according to claim 1, wherein the book page is a reading home page of the first book; the displaying, in the book page, a target topic matched with the first book, comprises:
displaying, in the book page, the target topic in a position adjacent to a display position of introduction information of the first book.

3. The method according to claim 1, wherein, subsequent to displaying a target topic matched with the first book, the method further comprises at least one of:
in response to a trigger operation directed to the target topic, displaying a target second book matched with the first book among the second books associated with the target topic, or, displaying a target topic review matched with the first book among the topic reviews included in the topic information.

4. The method according to claim 1, wherein the topic information includes at least one topic review;
the target topic is determined in such a manner as follows:
matching the topic information of initial topics and second books included in the initial topics with the first book respectively to determine candidate topics; wherein each of the candidate topics is matched with at least one of the topic reviews and the second books; and
determining the target topic from the candidate topics according to topic interaction data of the candidate topics and book reading conversion rate under the candidate topics.

5. The method according to claim 1, wherein the target topic is determined in such a manner as follows:
determining first plot information related to the book plot from the topic reviews included in the topic information of each initial topic, and determining second plot information of a second book included in the initial topic; and
screening out a target topic matched with third plot information of the first book from the initial topics, according to the first plot information and the second plot information.

6. The method according to claim 4, wherein the topic information of each of the initial topics is matched with the first book to determine candidate topics according to the following steps:
based on the topic title information, the topic introduction information and the matched book category as indicated by the topic information of each of the initial topics, determining first characteristic information corresponding to the initial topic;
based on the book title, the book introduction information and the book category of the first book, determining second characteristic information of the first book;
based on the first characteristic information and the second characteristic information, determining a first matching degree between the topic information of the initial topic and the first book; and
taking the initial topic with a corresponding first matching degree greater than a preset similarity threshold value as the candidate topic.

7. The method according to claim 4, wherein the second books included in each of the initial topics are matched with the first book to determine candidate topics according to the following steps:
for any one of the initial topics, in the case where there is a second book identical with the first book among the second books included in this initial topic, taking this initial topic as the candidate topic; or
in the case where there is no second book identical with the first book among the second books included in this initial topic, determining a second matching degree between each of the second books and the first book, and determining, in the initial topic, a first number of second books with a corresponding second matching degree greater than a preset similarity threshold value; and
in the case where the first number is greater than a first preset number, taking this initial topic as the candidate topic.

8. The method according to claim 4, wherein the topic information of each of the initial topics is matched with the first book to determine candidate topics according to the following steps:
for any one of the initial topics, determining third characteristic information of each topic review based on the book category of a second book and recommendation meaning information of a book recommendation reason in each topic review included in the initial topic;
based on the book category and the book introduction information of the first book, determining fourth characteristic information of the first book;
based on the third characteristic information of each topic review and the fourth characteristic information of the first book, determining a third matching degree between each of the topic reviews and the first book; and
if the second number of the topic reviews included in this initial topic is greater than a second preset number and there is a topic review with a corresponding third matching degree greater than the preset similarity threshold value in this initial topic, taking this initial topic as the candidate topic.

9. The method according to claim 4, wherein determining the target topic from the candidate topics according to topic interaction data of the candidate topics and book reading conversion rate under the candidate topics comprises:
in accordance with the topic interaction data of each of the candidate topics, selecting, from the candidate topics, candidate topics with an interaction data volume that is greater than or equals to a set data volume as to-be-determined topics; and
selecting, from the to-be-determined topics, the to-be-determined topic with the highest book reading conversion rate as the target topic.

10. The method according to claim 9, wherein the method further comprises:
if the interaction data volumes of topic interaction data of the candidate topics are all smaller than the set data volume, randomly selecting one of the candidate topics as the target topic.

11. A computer device, comprising: a processor and a memory, wherein the memory stores machine-readable instructions executable by the processor, the processor is used for executing the machine-readable instructions stored in the memory, and when the machine-readable instructions are executed by the processor, the processor implements a book page display method, comprising:
in response to a trigger operation on a first book, displaying a book page of the first book;
displaying, in the book page, a target topic matched with the first book; wherein at least one of the topic information of the target topic or second books included in the target topic is matched with the first book.

12. The device according to claim 11, wherein the book page is a reading home page of the first book; the displaying, in the book page, a target topic matched with the first book, comprises:
displaying, in the book page, the target topic in a position adjacent to a display position of introduction information of the first book.

13. The device according to claim 11, wherein, subsequent to displaying a target topic matched with the first book, the method further comprises at least one of:
in response to a trigger operation directed to the target topic, displaying a target second book matched with the first book among the second books associated with the target topic, or, displaying a target topic review matched with the first book among the topic reviews included in the topic information.

14. The device according to claim 11, wherein the topic information includes at least one topic review;
the target topic is determined in such a manner as follows:
matching the topic information of initial topics and second books included in the initial topics with the first book respectively to determine candidate topics; wherein each of the candidate topics is matched with at least one of the topic reviews and the second books; and
determining the target topic from the candidate topics according to topic interaction data of the candidate topics and book reading conversion rate under the candidate topics.

15. The device according to claim 11, wherein the target topic is determined in such a manner as follows:
determining first plot information related to the book plot from the topic reviews included in the topic information of each initial topic, and determining second plot information of a second book included in the initial topic; and
screening out a target topic matched with third plot information of the first book from the initial topics, according to the first plot information and the second plot information.

16. A non-transitory computer-readable storage medium, wherein the computer-readable storage medium stores thereon a computer program, and when the computer program is executed by a computer device, the computer device implements a book page display method, comprising:
in response to a trigger operation on a first book, displaying a book page of the first book;
displaying, in the book page, a target topic matched with the first book; wherein at least one of the topic information of the target topic or second books included in the target topic is matched with the first book.

17. The medium according to claim 16, wherein the book page is a reading home page of the first book; the displaying, in the book page, a target topic matched with the first book, comprises:
displaying, in the book page, the target topic in a position adjacent to a display position of introduction information of the first book.

18. The medium according to claim 16, wherein, subsequent to displaying a target topic matched with the first book, the method further comprises at least one of:
in response to a trigger operation directed to the target topic, displaying a target second book matched with the first book among the second books associated with the target topic, or, displaying a target topic review matched with the first book among the topic reviews included in the topic information.

19. The medium according to claim 16, wherein the topic information includes at least one topic review;
the target topic is determined in such a manner as follows:
matching the topic information of initial topics and second books included in the initial topics with the first book respectively to determine candidate topics; wherein each of the candidate topics is matched with at least one of the topic reviews and the second books; and
determining the target topic from the candidate topics according to topic interaction data of the candidate topics and book reading conversion rate under the candidate topics.

20. The medium according to claim 16, wherein the target topic is determined in such a manner as follows:
determining first plot information related to the book plot from the topic reviews included in the topic information of each initial topic, and determining second plot information of a second book included in the initial topic; and
screening out a target topic matched with third plot information of the first book from the initial topics, according to the first plot information and the second plot information.
